(19) United States
(12) Patent Application Publication
(10) Pub. No.: US 2009/0037604 A1
(43) Pub. Date: Feb. 5, 2009

(54) MANAGEMENT SYSTEM FOR CONVERTING COMMANDS IN TERMINAL TYPES AND METHOD THEREOF

(75) Inventors: Wen Zhang, Shijr City (TW); Ming-jian Liu, Shijr City (TW)

Correspondence Address: AUSTIN RAPP & HARDMAN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/832,025

(22) Filed: Aug. 1, 2007

(51) Int. Cl. G06F 15/16

(52) U.S. Cl. 709/246

(57) ABSTRACT

A management system for converting commands in the terminal types and method thereof are disclosed. The management system couples a computing device, having a first terminal type, to a terminal. The management system includes a detecting unit, a conversion table, and a converting unit. The detecting unit of the management system detects whether the terminal has a second terminal type. The conversion table constitutes a conversion relationship between a first set of commands in the first terminal type and a second set of commands in the second terminal type correspondingly. The converting unit, in response to the detecting unit, converts the first set of commands in the first terminal type from the computing device into the second set of commands in the second terminal type according to the conversion table if the first set of commands in the first terminal type is unreadable for the terminal. Thus, the computing device controls the terminal to display correctly.

### FIELD OF THE INVENTION

The present invention relates to a management system and method thereof, and more particularly to a management system capable of converting the commands between a terminal having a first terminal type and a computing device having a second terminal type for displaying images correctly.

### BACKGROUND OF THE INVENTION

Telnet connection is a bi-directional character-oriented communication application primarily designed to provide a virtual terminal (VT) process via a network. The communication application allows a client computer and a server computer on the network to communicate one another. Therefore, a user on a terminal connected to client computer could communicate with a server computer as if the terminal of the client computer is directly connected to the computing device. Once the telnet connection between the terminal and the server computer is established, user's inputs from the terminal must be transferred to the server computer and the outputs from the server computer should be transferred back to the terminal.

However, since there are a variety of terminal types in the market, it is necessary to devise a management system such that the terminals of the client computer and the server computer can match and communicate one another. Otherwise, when the characters are transferred from the server computer to the terminal of the client computer, the characters shown on the terminal will be in a state of chaos and cannot correctly display the characters. Particularly, when the terminal type of the client computer is different from the terminal type of the server computer, the user on the client computer cannot perform the instructions of the content composed of the characters from the server computer. Consequently, it is required to develop a novel management system to solve the above-mentioned problem.

### SUMMARY OF THE INVENTION

One objective of the present invention is to provide a management system and method for converting commands so that the commands in the first terminal type from the computing device is readable for the terminal having the second terminal type correctly.

Another objective of the present invention is to provide a management system and method for translating the characters and the attributes according to the second terminal type for showing the image on the terminal correctly.

According to the above objectives, the management system includes a detecting unit, a storage unit, a converting unit, a first switch, a second switch, and a conversion table. The management system couples the terminal to the computing device the first computing device. The detecting unit detects whether the first terminal has the second terminal type. The storage unit is capable of storing a plurality of characters and attributes generated from the first computing device based on the first terminal type of the first computing device. If a first set of commands in the first terminal type from the first computing device is unreadable for the terminal, the converting unit converts the first set of commands in the first terminal type of the first computing device into a second set of commands in the second terminal type of the first terminal according to the conversion table. For example, the characters and the attributes constituting an image in the first set of commands is translated according to the second terminal type of the first terminal for showing the image on the first terminal correctly.

In operation, the method for the management system includes the following steps:

The detecting unit determines a first terminal type of a computing device. In one case, before determining the first terminal type, the detecting unit queries the computing device for detecting the first terminal type of the computing device. In another case, before determining the first terminal type, the detecting unit sets the first terminal type according to the response of the computing device.

The detecting unit detects a second terminal type of a terminal. The detecting unit issues a first identifying command and a second identifying command to the terminal. In one case, if the terminal replies only a first message corresponding to the first identifying command, it indicates that the terminal cannot identify the second identifying command. In another case, the terminal replies both of the first message and a second message corresponding to the first identifying command and the second identifying command, respectively, for detecting the second terminal type because the terminal with the second terminal type is capable of identifying the first identifying command and the second identifying command. For example, the detecting unit issues a first identifying command in VT52 and a second identifying command in VT100 to the terminal. If the terminal only replies a first message in VT52, it indicates that the second terminal type of the terminal is VT52 terminal. On the contrary, if the terminal replies the first message in VT52 and a second message in VT100, it indicates that the second terminal type of the terminal is VT100 terminal.

The converting unit determines whether a first set of commands in the first terminal type from the computing device is readable for the terminal or not. If the decision result is “NO”, the converting unit converts the first set of command in the first terminal type of the computing device into a second set of command in the second terminal type of the terminal according to a conversion table. If the decision result is “YES”, proceed to end the flow chart. That is, the first set of commands in the second terminal type is readable for the terminal, and the first set of commands in the first terminal type may be readable for the terminal.

The converting unit further translates the characters and the attributes constituting an image according to the second terminal type for showing the image on the terminal. The attributes include a plurality of colors of the characters, respectively, and the attributes include a plurality of background colors of the characters on the display, respectively.

In detail, the conversion table constitutes a conversion relationship between the first set of commands in the first terminal type and the second set of commands in the second terminal type correspondingly. The conversion table between the first terminal type and the second terminal type can be installed in the management system such that the converting unit performs the conversion between the first set of commands in the first terminal type of the computing device and the second set of commands in the second terminal type of the terminal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart of performing the management system according to one embodiment of the present invention;

FIG. 2A is an image including characters and attributes transmitted from the computing device to the management system if the first set of commands in the first terminal type is readable for the terminal according to one embodiment of the present invention;

FIG. 2B is the image including characters, attributes and commands from the computing device to the management system if the first set of commands in the first terminal type is unreadable for the terminal according to one embodiment of the present invention;

FIG. 2C is the image including characters and attributes wherein the first set of commands are not directly shown on the image even if the first set of commands in the first terminal type shown in FIG. 2B is unreadable for the terminal according to one embodiment of the present invention; and

FIG. 3 is a management system according to one embodiment of the present invention.

### DETAILED DESCRIPTION OF THE INVENTION

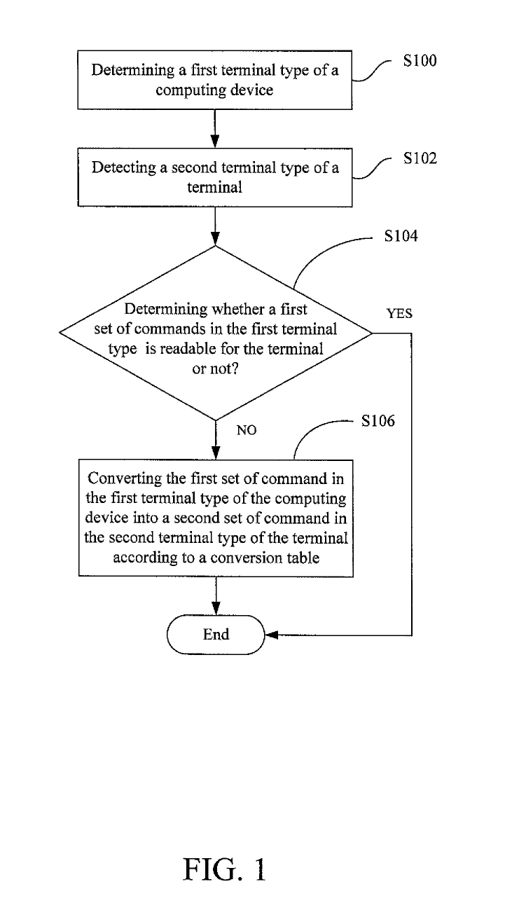

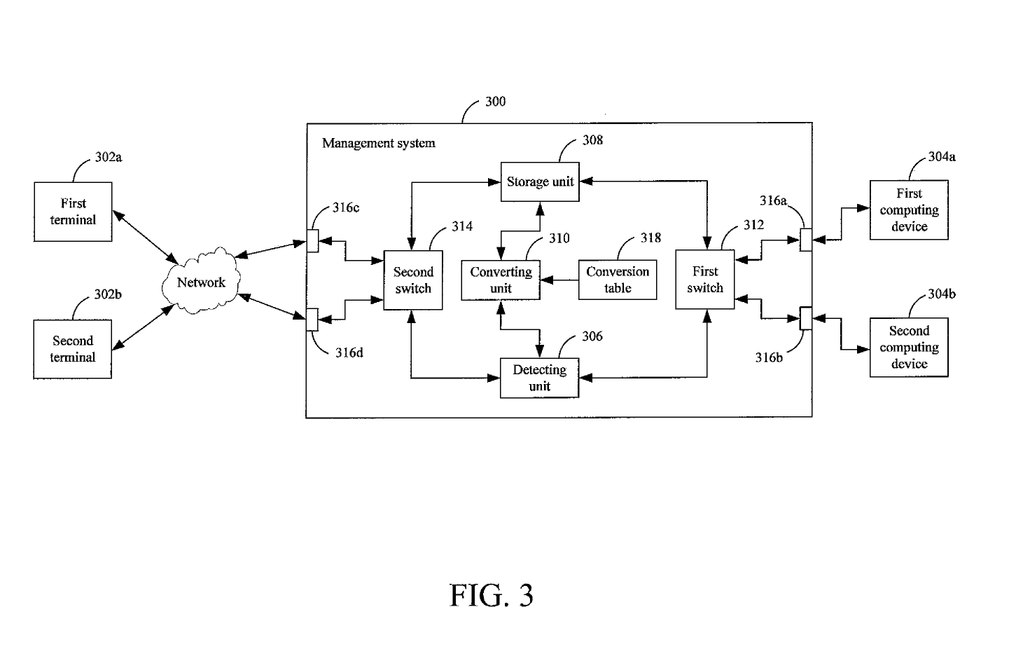

Please refer to FIG. 1 which is a flow chart depicting the steps performed by the management system 300 shown in FIG. 3 according to one embodiment of the present invention. The management system 300 is a control unit that provides both In-Band and Out-of-Band remote access to up to sixteen servers or other serial information technology (IT) devices (e.g. hubs, routers, power management device, etc.), via a Telnet or SSH TCP/IP connection. Users can login at the same time from any computer connected to the Internet, whether down the hall, or half way around the world. Each user is able to control a separate port so that attached devices can be accessed at the same time.

The management system 300 includes a detecting unit 306, a storage unit 308, a converting unit 310, a first switch 312, a second switch 314, and a conversion table 318, which are depicted in FIG. 3 in detail. The flow chart includes the steps as follows:

In step S100, the detecting unit 306 determines a first terminal type of a computing device. In one case, before determining the first terminal type, the detecting unit 306 queries the computing device for detecting the first terminal type of a computing device, such as a server computer. In another case, before determining the first terminal type, the detecting unit 306 sets the first terminal type according to the response of the computing device. In one embodiment the first terminal type may be video terminal 52 (abbreviated as VT52), VT100, VT220 and VT320.

In step S102, the detecting unit 306 detects a second terminal type of a terminal. The detecting unit 306 issues a first identifying command and a second identifying command to the terminal. The second terminal type may also be VT52, VT100, VT220 and VT320. In one case, the terminal replies a first message corresponding to the first identifying command for detecting the second terminal type. In another case, the terminal replies the first message and a second message corresponding to the first identifying command and the second identifying command, respectively, for detecting the second terminal type because the terminal with the second terminal type is capable of identifying the first identifying command and the second identifying command. For example, the detecting unit 106 issues a first identifying command in VT52 and a second identifying command in VT100 to the terminal. If the terminal only replies a first message in VT52, it indicates that the second terminal type of the terminal is VT52 terminal. On the contrary, if the terminal replies the first message in VT52 and a second message in VT100, it indicates that the second terminal type of the terminal is VT100 terminal. Additionally, it should be noted that subsequent versions of the first terminal type and the second terminal type may be used in the management system 300 of the present invention.

In step S104, the converting unit 310 determines whether a first set of commands in the first terminal type from the computing device is readable for the terminal or not. If the decision result is “NO”, the converting unit 310 converts the first set of command in the first terminal type of the computing device into a second set of command in the second terminal type of the terminal according to a conversion table 118, as shown in step S106. If the decision result is “YES”, proceed to end the flow chart. That is, the first set of commands in the second terminal type is readable for the terminal, and the first set of commands in the first terminal type may be readable for the terminal.

For example, if the first set of commands from the computing device is in VT200 but the terminal is a VT100 terminal, the commands is unreadable for the terminal. As a result, the computing device is unable to control the terminal to display correctly. However, if the first set of commands from the computing device is in VT100 and the terminal is a VT200 terminal, the first set of commands is readable for the terminal. Therefore, the computing device is able to control the terminal to display correctly via the management system 300.

During the step S106, the converting unit 310 further translates the characters and the attributes of the first set of command, constituting an image, according to the second terminal type for showing the image on the terminal. The attributes include a plurality of underlining, blinking, and foreground and background colors of the characters.

In detail, the conversion table 318 shown in FIG. 3 constitutes a conversion relationship between the first set of commands in the first terminal type and the second set of commands in the second terminal type correspondingly. The conversion table 318 between the first terminal type and the second terminal type can be installed in the management system 300 such that the converting unit 310 performs the conversion between the first set of commands in the first terminal type of the computing device and the second set of commands in the second terminal type of the terminal. For example, please refer to Conversion Table (I) and Conversion Table (II) below.

Conversion Table (I) partially lists the conversions of VT52 commands into VT100 commands. Command “ESC A” in VT52 terminal represents the control operation of “cursor up” for the characters (202a, 202b, and 202c) of the image (200a, 200b, and 200c), which is equivalent operation to command “ESC [A” in VT100 terminal.

Command “ESC B” in VT52 terminal represents the control operation of “cursor down”, equivalent to command “ESC [B” in VT100 terminal.

Command “ESC=” in VT52 terminal represents the control operation of “entering alternate keypad mode”, equivalent to the same command “ESC=” in VT100 terminal.

Command “ESC]” in VT52 terminal represents the control operation of “print screen”, equivalent to command “ESC [i” in VT100 terminal.

Command “ESC ̂” in VT52 terminal represents the control operation of “entering auto print mode”, equivalent to command “ESC [?5i” in VT100 terminal.

Further, Conversion Table (II) partially lists the conversions of VT100 commands into VT52 commands. Command “ESC [J” in VT100 terminal represents the control operation of “erasing to end of screen “for the characters (202a, 202b, and 202c) of the image (200a, 200b, and 200c), which is equivalent operation to command “ESC J” in VT52 terminal.

Command “ESC [K” in VT100 terminal represents the control operation of “erasing to end of line”, equivalent to command “ESC K” in VT52 terminal.

Command “ESC=” in VT100 terminal represents the control operation of “entering alternate keypad mode”, equivalent to the same command “ESC=” in VT52 terminal.

Command “[4i” in VT100 terminal represents the control operation of “exiting printer controller mode”, equivalent to command “ESC X” in VT52 terminal.

Command “ESC [1i” in VT100 terminal represents the control operation of “printing cursor line”, equivalent to command “ESC [?5i” in VT52 terminal.

Person skilled in the art should be noted that the converting unit 310 may perform the conversion table between arbitrary terminal types.

Conversion Table (I)

| VT52 commands | VT100 commands |
|---|---|
| ESC A | ESC [A |
| ESC B | ESC [B |
| ESC = | ESC = |
| ESC ] | ESC [i |
| ESC \hat{ } | ESC [?5i |

Conversion Table (II)

| VT100 commands | VT52 commands |
|---|---|
| ESC [J | ESC J |
| ESC [K | ESC K |
| ESC = | ESC = |
| ESC [4i | ESC X |
| ESC [1i | ESC V |

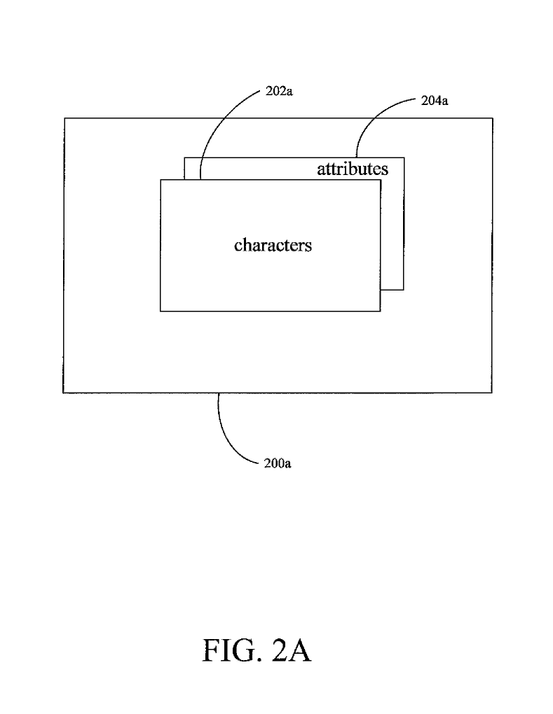

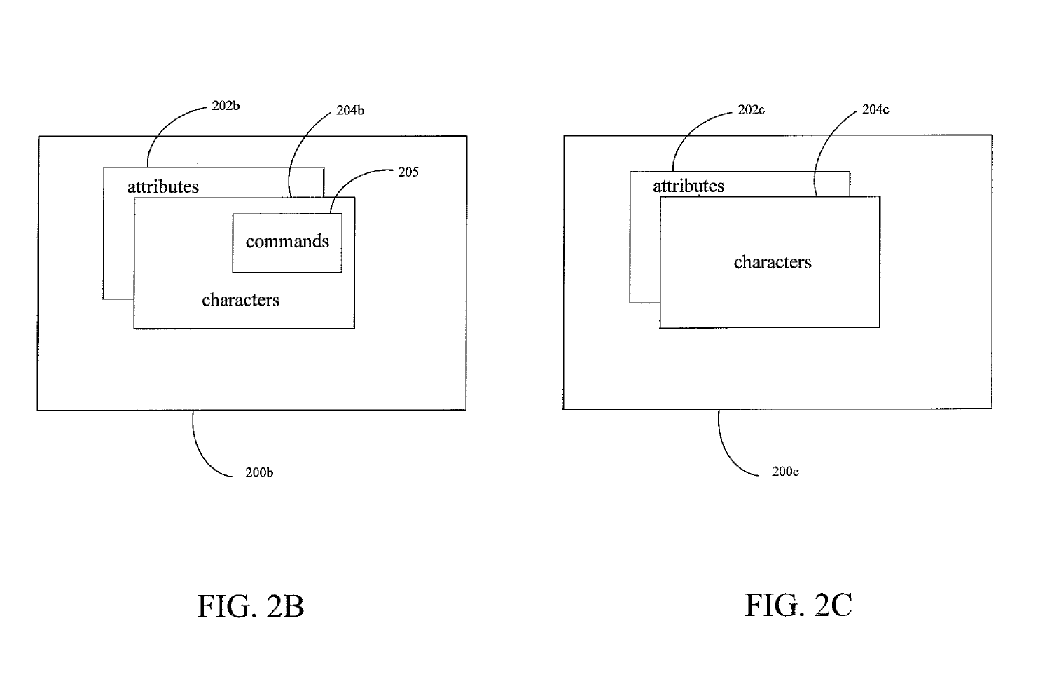

Please refer to FIG. 1 and FIG. 2A which depicts an image 200a including characters and attributes transmitted from the computing device to the management system 300 if the first set of commands in the first terminal type is readable for the terminal during step S104 in FIG. 1 according to one embodiment of the present invention. The image 200a is composed of characters 202a and attributes 204a from the computing device. In one case, the second terminal type of the terminal is the same as the first terminal type of the computing device. In other words, the first terminal type of the computing device matches the second terminal type of the terminal. In another case, the second terminal type is different from the first terminal type, but the first terminal type is downward compatible with the second terminal type. For example, the first terminal type of the computing device is VT52 terminal and the second terminal type of the terminal VT100 terminal which is compatible with the first terminal type, i.e. VT52 terminal. Thus, the terminal is capable of reading the first set of commands in the first terminal type from the computing device and correctly displays the characters and attributes of the image 202a.

Please refer to FIG. 1 and FIG. 2B which depicts the image 200b, including characters 202b, attributes 204b and commands, in response to the first set of commands, from the computing device to the management system 300 if the first set of commands in the first terminal type is unreadable for the terminal during step S304 in FIG. 1 according to one embodiment of the present invention. In this case, the terminal cannot display correctly in response to the first set of commands. The image 200b is composed of characters 202b, attributes 204b and the first set of commands 205 from the computing device. Due to the first set of command 205 associated with the control operation of the characters 202b, the image 200b will be in a state of chaos when the image 200b is directly displayed on the terminal. The second terminal type of the terminal is different from the first terminal type of the computing device and the first terminal type is not compatible with the second terminal type. For example, the first terminal type of the computing device is VT100 terminal and the second terminal type of the terminal is VT52 terminal which is lower than the first terminal type, i.e. VT100 terminal. Thus, the second terminal type doesn't match with the first terminal type so that the terminal cannot read out the characters 202a and attributes 204a from the computing device and display on the terminal.

Therefore, it is required that the converting unit 310 converts the first set of command into a second set of command during the step S106. The converting unit 310 further translates the characters and the attributes constituting an image.

Please refer to FIG. 1 and FIG. 2C which only depicts the image 200c including characters 202c and attributes 204c wherein the first set of commands 205 are not directly shown on the image 200b even if the first set of commands in the first terminal type shown in FIG. 2B is unreadable for the terminal according to one embodiment of the present invention.

The image 200c is composed of characters 202c and attributes 204c shown in FIG. 2C, and the first set of commands 205 shown in FIG. 2B are correctly performed and not shown on the image. The converting unit 310 converts the first set of command in the first terminal type into a second set of command in the second terminal type according to the conversion table 318 during the step S106. That is, the user on the terminal is capable of performing the commands 205 to process the characters 202b and the attributes 202b from the computing device, and thus the first set of commands 205 are not directly shown on the terminal even if the first set of commands in the first terminal type shown in FIG. 2B is unreadable for the terminal The converting unit 310 then further translates the characters 202b and the attributes 202b from the computing device shown in FIG. 2B into the characters 202c and the attributes 202c shown in FIG. 2C according to the second set of commands in the second terminal type of the terminal.

Please refer to FIG. 3 which depicts a management system 300 according to one embodiment of the present invention. The management system 300 can be SN0108 or SN0116 with updated firmware, manufactured by ATEN International Co., Ltd.

The management system 300 is capable of coupling one or more terminals, e.g. a first terminal 302a and a second terminal 302b, having a second terminal type to one or more computing devices, e.g. a first computing device 304a and a second computing device 304b, having a first terminal type. The management system 300 includes a detecting unit 306, a storage unit 308, a converting unit 310, a first switch 312, a second switch 314, and a conversion table 318 coupled to the converting unit 310. In one embodiment, the first terminal 302a establishes a telnet connection to login to the first computing device 304a and the second computing device 304b via the management system 300 as if the first terminal 302a is directly connected to the first computing device 304a and the second computing device 304b.

The detecting unit 306 is coupled to the first switch 312 and the second switch 314, respectively. The storage unit 308 is coupled to the first switch 312 and the second switch 314, respectively. The converting unit 310 couples the detecting unit 306 to the storage unit 308. The conversion table 318 constitutes a conversion relationship between the first set of commands in the first terminal type and the second set of commands in the second terminal type correspondingly.

The first switch 312 couples the storage unit 308 and the detecting unit 306 to one of the first computing device 304a and the second computing device 304b via a first port 316a and a second port 36b, respectively. The second switch 314 couples the storage unit 308 and the detecting unit 306 to one of the first terminal 302a and the second terminal 302b via a third port 316c and a fourth port 316d, respectively. In one embodiment the third port 316c and a fourth port 316d are connected to the first terminal 102a and the second terminal 102b, respectively, via a network, such as a LAN or the Internet.

The management system 300 couples the terminal, such as a first terminal 302a, to the computing device, such as the first computing device 304a. The detecting unit 306 detects whether the first terminal 302a has the second terminal type. The storage unit 308 is capable of temporarily storing a plurality of characters and attributes generated from the first computing device 304a based on the first terminal type of the first computing device 304a. If a first set of commands in the first terminal type from the first computing device 304a is unreadable for the terminal, the converting unit 310 converts the first set of commands in the first terminal type of the first computing device 304a into a second set of commands in the second terminal type of the first terminal 302a according to the conversion table 318. For example, the characters and the attributes constituting an image in the first set of commands is translated according to the second terminal type of the first terminal 302a for showing the image on the first terminal 302a correctly.

Continuously referring to FIG. 3, since the first switch 312 is switched to the first computing device 304a via the first port 316a and switched to the second computing device 304b via the second port 316b, the detecting unit 306 can detect the first terminal type of the first computing device 304a and the second computing device 304b by communicating with the first computing device 304a and the second computing device 304b. Similarly, since the second switch 314 is switched to the first terminal 302a via the third port 316c and switched to the second terminal 302b via the fourth port 316d, the detecting unit 306 can detect the second terminal type of the first terminal 302a and the second terminal 302b by communicating with the first terminal 302a and the second terminal 302b.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A management system, capable of coupling a computing device having a first terminal type to a terminal, the management system comprising:
a detecting unit coupled to the terminal and the computing device, detecting whether the terminal has a second terminal type;
a conversion table constituting a conversion relationship between a first set of commands in the first terminal type and a second set of commands in the second terminal type correspondingly; and
a converting unit, in response to the detecting unit, converting the first set of commands in the first terminal type from the computing device into the second set of commands in the second terminal type according to the conversion table, if the first set of commands in the first terminal type is unreadable for the terminal thereby the computing device controlling the terminal to display correctly.

2. The management system of claim 1, wherein the converting unit further translates a plurality of characters and a plurality of attributes constituting an image according to the second terminal type for showing the image on the terminal correctly.

3. The management system of claim 1, wherein the detecting unit detects whether the terminal has the second terminal type by issuing a first identifying command and a second identifying command to the terminal.

4. The management system of claim 3, wherein the detecting unit receives a response of a first message and a second message from the terminal corresponding to the first identifying command and the second identifying command, respectively, for detecting the second terminal type.

5. The management system of claim 3, wherein the detecting unit receives both of the first message and the second message from the terminal corresponding to the first identifying command and the second identifying command, respectively, for detecting the second terminal type.

6. The management system of claim 1, wherein the first terminal type of the computing device is selected from a group consisting of VT52, VT100, VT220 and VT320.

7. The management system of claim 1, wherein the second terminal type of the terminal is selected from a group consisting of VT52, VT100, VT220 and VT320.

8. The management system of claim 1, wherein the terminal establishes a connection to login to the computing device via the management system as if the terminal is directly connected to the computing device.

9. A management system comprising:
a terminal coupled to a computing device having a first terminal type via the management system;
a detecting unit coupled to the terminal and the computing device, detecting whether the terminal has a second terminal type;
a conversion table constituting a conversion relationship between a first set of commands in the first terminal type and a second set of commands in the second terminal type correspondingly; and
a converting unit, in response to the detecting unit, converting the first set of commands in the first terminal type from the computing device into the second set of commands in the second terminal type according to the conversion table, if the first set of commands in the first terminal type is unreadable for the terminal for allowing the computing device to control the terminal to display correctly.

10. The management system of claim 9, wherein the converting unit further translates a plurality of characters and a plurality of attributes constituting an image according to the second terminal type for showing the image on the terminal correctly.

11. The management system of claim 9, wherein the detecting unit detects whether the terminal has the second terminal type by issuing a first identifying command and a second identifying command to the terminal.

12. The management system of claim 11, wherein the detecting unit receives a response of a first message and a second message from the terminal corresponding to the first identifying command and the second identifying command, respectively, for detecting the second terminal type.

13. The management system of claim 11, wherein the detecting unit receives the first message and the second message from the terminal corresponding to the first identifying command and the second identifying command, respectively, for detecting the second terminal type.

14. The management system of claim 9, wherein the first terminal type of the computing device is selected from a group consisting of VT52, VT100, VT220 and VT320.

15. The management system of claim 9, wherein the second terminal type of the terminal is selected from a group consisting of VT52, VT100, VT220 and VT320.

16. The management system of claim 9, wherein the terminal establishes a connection to login to the computing device via the management system as if the terminal is directly connected to the computing device.

17. A method for a management system allowing a computing device having a first terminal type to control a terminal coupled thereto, the method comprising the steps of:
determining the first terminal type of the computing device;
detecting whether the terminal has a second terminal type; and
converting a first set of commands in the first terminal type from the computing device into a second set of commands in the second terminal type of the terminal if the first set of commands is unreadable for the terminal.

18. The method of claim 17, before the step of determining the first terminal type of the computing device, further comprising querying the first terminal type of the computing device.

19. The method of claim 17, before the step of determining the first terminal type of the computing device, further comprising setting the first terminal type of the computing device according to the response of the computing device.

20. The method of claim 17, during the step of detecting the second terminal type of the terminal, further comprising a step of issuing a first identifying command and a second identifying command to the terminal.

21. The method of claim 20, after the step of issuing the first identifying command and the second identifying command to the terminal, further comprising a step of receiving a response of a first message and a second message from the terminal corresponding to the first identifying command and the second identifying command, respectively, for detecting the second terminal type.

22. The method of claim 20, after the step of issuing the first identifying command and the second identifying command to the terminal, further comprising a step of receiving a first message and a second message from the terminal corresponding to the first identifying command and the second identifying command, respectively, for detecting the second terminal type.

23. The method of claim 17, wherein the first terminal type of the computing device is selected from a group consisting of VT52, VT100, VT220 and VT320.

24. The method of claim 17, wherein the second terminal type of the terminal is selected from a group consisting of VT52, VT100, VT220 and VT320.

25. The management system of claim 17, wherein the terminal establishes a connection to login to the computing device via the management system as if the terminal is directly connected to the computing device.

26. The management system of claim 25, wherein the connection is a telnet connection.
